(19) United States
(12) Patent Application Publication
(10) Pub. No.: US 2009/0175495 A1
(43) Pub. Date: Jul. 9, 2009

(54) IMAGE PROCESSING DEVICE AND METHOD, AND PROGRAM FOR THE SAME

(75) Inventors: Nobuo KAMEI, Osaka-shi (JP); Takeshi MORIKAWA, Takarazauka-shi (JP); Kei SHIGEHISA, Amagasaki-shi (JP); Takeshi MINAMI, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/348,117

(22) Filed: Jan. 2, 2009

(30) Foreign Application Priority Data
Jan. 8, 2008 (JP) 2008-001525

(51) Int. Cl. G06K 9/00; G06F 3/12

(52) U.S. Cl. 382/100; 358/1.15

(57) ABSTRACT

The image processing device includes: a detection unit that detects embedded additional data; an extraction unit that extracts additional information; a storage unit that stores the data of the document and the detailed information; a search unit that acquires a stored document and detailed information thereof; a generation unit that generates thumbnail image data of pages of a stored document; a post-processing unit that processes the thumbnail image data; and a display device that displays the detailed information of the stored document and the thumbnail image data, wherein the thumbnail image of the same page as the page of the printed document is displayed on the display device, in a second display method different from a first display method that is a method of displaying a thumbnail image expressing the page other than the page of the printed document.

This application is based on an application No. 2008-001525 filed in Japan, the contents of which are hereby incorporated by reference.

### BACKGROUND OF THE INVENTION

1. Field of the Invention

The present invention relates to an image processing device and particularly relates to the image processing device that optically reads a page of a printed document, then detects additional data embedded in this page, extracts additional information expressed by this additional data, and executes prescribed processing based on this additional information. Also, the present invention relates to a method of image processing including this prescribed processing, and a program for the same.

2. Description of the Related Art

In a field of the image processing device, a so-called Multifunction Peripheral (MFP), a Scan Print copy (SPC), or an All In One (AIO) are popular in the market. Here, the digital multifunction peripheral indicates the image processing device having at least two or more functions of a copier, a printer, a scanner and a facsimile equipment, etc.

The digital multifunction peripheral serves as an image processing device that performs various image processing by processing information, expressed as data of a digital format. Therefore, element technologies of the digital multifunction peripheral have a high affinity with an information processing technology and a network technology, and technologies developed in those technical fields can be easily introduced. Progress of research in the information processing technology and the network technology in recent years make it possible to further accelerate high function/multi function of the digital multifunction peripheral (called simply a “multi function peripheral” hereafter).

For example, there is a multifunction peripheral including a communication interface and connected to a network such as the Internet or a local area network (LAN). Also, there are a plurality of multifunction peripherals including a storage device inside or outside of the multifunction peripheral and storing data concerning the image processing in this storage device (such as a hard disk drive (HDD)).

A user can operate the multifunction peripheral, print the data stored in the storage device on a paper medium, transmit the data by a facsimile function, or transmit the data to a prescribed mail address as an e-mail. In recent years, the multifunction peripheral appears, capable of performing processing such as storing the data of a document in the storage device, then scanning additional data embedded in the page of the printed document using the multifunction peripheral, thereby outputting the data of the document stored in the storage device on the paper medium by the multifunction peripheral, based on information indicated by this additional data.

Examples of the image processing device including the storage device will be referenced hereunder.

For example, JP 2004-153566 A discloses an image processing system capable of obtaining output without image deterioration at all times.

In this image processing system, an inputted image is stored in an image storing section as image data, and a storage location and a file name of this image data in the image storing section are added to a printed matter of this inputted image, as an electronic watermark. Thereafter, in the image processing system, when the aforementioned printed matter is scanned, the electronic watermark included in the printed matter is detected, then information regarding the storage location and the file name in the image storing section of the image data corresponding to the aforementioned printed matter is acquired, and based on the acquired information, the image data is acquired from the image storing section to print this image. Thus, the image processing system of JP 2004-153566 A is capable of preventing the image deterioration concerning duplicate output of the image.

In addition, for example, JP 2005-267338 A discloses an image data storing and printing method using the multifunction peripheral having a facsimile function.

According to this method, the data received by a facsimile function of the multifunction peripheral is stored in a database as image data. When the image data is stored in the database, information regarding the file name, etc, of this image data in the database is embedded in the image data as the electronic watermark. The image data stored in the database embedded with the electronic watermark can be suitably outputted as the printed matter.

Thereafter, when the printed matter of the image data embedded with the electronic watermark is duplicated, the multifunction peripheral detects the electronic watermark embedded in the printed matter, and based on the information indicated by the electronic watermark, calls the image data stored in the database, and outputs this image data as a duplicate of the aforementioned printed matter. Thus, when the printed matter is copied, the image data storing method of JP 2005-267338 A is capable of outputting initial data received by facsimile equipment.

In addition, for example JP 2006-217276 A discloses an image forming apparatus.

This image forming apparatus extracts a character string from a prescribed area of a document by using an OCR function, when the image of the document is scanned. Then, when a prescribed character string (item) is included in the extracted character string, the image forming apparatus executes search for the character string (item) in the database, and acquires information regarding the character string (item) from the database. Then, the image forming apparatus displays the acquired information to a user, in duration up to completion of the image forming processing. The user can acquire the information in the duration up to completion of the image forming processing and efficient utilization of time can be encouraged.

As described above, there are a plurality of image processing devices which are capable of outputting the data stored in the storage device, based on the additional information extracted by detecting the electronic watermark, etc, included in the page of the printed document that is in user's own hand.

Incidentally, it is a matter of course that numerous numbers of data files are stored in the storage device of the image processing device. Such numerous numbers of data files also include the data file having some relation with the data file for utilization. In utilizing the data file, it is important to provide information regarding the data file having such relation to the user for improving usability of the image processing device.

Explanation will be given hereunder, for an example of a technique of providing information regarding other data file having relation with the above data file.

For example, JP 2005-267338 A discloses a file management system.

This file management system includes a file management server and a client. The file management server manages files and file related information. Meanwhile, the client has a section that stores duplicate files of the files managed by the file management server; a section that acquires the information of other files related to the duplicate files from the file management server; and a section that displays the duplicate files and the related other files.

This client provides to the user, the related information regarding the files utilized by the user, even in a case of utilizing the duplicate files stored by the client, as well in a case of utilizing the files managed by the file management server. Thus, in the file management system of JP 2005-267338 A, in utilizing each duplicate file that exists in the client, the usability concerning file utilization of the user can be improved by providing the information of other files that exists in the system.

Also, for example, JP 2002-236649 A discloses a related document processing apparatus.

This related document processing apparatus includes a document storing section that stores documents (such as electronic mails); a relation detecting section that detects relation of a plurality of electronic mails/documents by analyzing headers of the electronic mails; and a specifying section that specifies a final document in time series from the document indicated by the relation detected by the relation detecting section.

The related document processing apparatus of JP 2002-236649 A can automatically specify the final document in time series from a series of documents interconnected by prescribed relation, and therefore it is not necessary for the user to sequentially read through all of the series of electronic mails and documents having the prescribed relation in time series, thus making it possible to achieve work efficiency.

Thus, there are disclosed a plurality of methodologies of searching other data file having prescribed relation with a specific data file (document) and executing prescribed processing to the data file having the prescribed relation.

As described above, in the storage device of the multifunction peripheral, numerous numbers of data files are stored and among them, there are data file groups mutually having some relation. In the multifunction peripheral also, the information regarding the data file group having prescribed relation with the data file for utilization is desired to be provided to the user in a method of improving the usability for the user, when the data file stored in the storage device is utilized based on the additional data embedded in the page of the printed document. Needless to say, here, the data files include the data file that holds the information included in the document.

However, in a conventional image processing device, a main utilization purpose of the additional information expressed by the additional data embedded in the page of the printed document is to print the corresponding document/data file. In the print of the corresponding document/data file, information such as a storage location of this document/data file in the storage device of the image processing device is only presented to the user, when the corresponding document/data file is printed.

Therefore, in the conventional image processing device, the user cannot know the relation between the page of the printed document at hand used in scanning and an entire body of the document, until the document/data file is printed out. For example, the user can not know which piece in the entire body of the document the page of the printed document at hand used in an input of the additional information into the image processing device is included in, until the printout of the document is completed.

Also, in a case of the input of the additional information of a plurality of pages into the image processing device by scanning the plurality of pages of the printed document, the user can not know whether a single document is constituted of the printed document of the plurality of pages at hand, or is included in each one of a plurality of documents.

Further, when the corresponding document/data file stored in the storage device of the image processing device is printed out by scanning the page of the printed document at hand by the user, the user can not know existence of other document/data file, even if other document/data file having some relation with the printed-out document/data file is stored in this storage device.

### SUMMARY OF THE INVENTION

In view of the above-described problems, one of the objects of the present invention is to provide the image processing device capable of providing to the user, detailed information regarding a relation between the page of the printed document and the corresponding document/data file stored in the storage device, without printing out this document/data file.

First aspect of the present invention is an image processing device capable of inputting an image of a page of a printed document. The image processing device includes: an additional data detection unit that detects additional data included in image data of the image of the page of the printed document; an additional information extraction unit that extracts additional information indicated by the additional data; a storage unit that stores data of the document and data of detailed information of the document; a document information search unit that acquires the data of the document stored in the storage unit including the page of the printed document, and the data of the detailed information of the stored document; a thumbnail image data generation unit that generates thumbnail image data of the page of the stored document by processing the data of the stored document, based on the additional information; a thumbnail image data post-processing unit that processes the thumbnail image data, based on the additional information; and a display device that displays at least a part of information indicated by the data of the detailed information of the stored document, and the thumbnail image data processed by the thumbnail image data post-processing unit, wherein the image processing device displays the thumbnail image data expressing the same page as the page of the printed document on the display device, in a second display method different from a first display method that is a method for displaying the thumbnail image data expressing the page included in the stored document and the page other than the page of the printed document.

Second aspect of the present invention is an image processing method for processing an image of a page of a printed document. The image processing method includes: inputting the image of the page of the printed document; detecting additional data included in image data of the image of the page of the printed document; extracting additional information indicated by the additional data; acquiring data of the document stored in a storage unit, including the page of the printed document, and acquiring the data of detailed information of the stored document, based on the additional information; generating a thumbnail image data of the page of the stored document, by processing the data of the stored document, based on the additional information; processing the thumbnail image data based on the additional information; and displaying the thumbnail image data processed in the step of processing at least a part of information indicated by the data of the detailed information of the stored document and the thumbnail image data, the displaying includes displaying the thumbnail image data expressing the same page as the page of the printed document, in a second display method different from a first display method that is a method of displaying the thumbnail image data expressing the page included in the stored document and the page other than the page of the printed document.

Third aspect of the present invention is a computer-readable medium storing an image processing program executed by a computer of an image processing device capable of inputting an image of a page of a printed document. The program includes: code that inputs an image of a page of a printed document; code that detects additional data included in image data of the image of the page of the printed document; code that extracts additional information indicated by the additional data; code that acquires data of the document stored in a storage unit of the image processing device, including the page of the printed document, and acquires data of detailed information of the stored document based on the additional information; code that generates thumbnail image data of the page of the stored document by processing the data of the stored document based on the additional information; code that processes the thumbnail image data based on the additional information; and code that displays on a display device of the image processing device, at least a part of information indicated by the data of the detailed information of the stored document, and the thumbnail image data processed in the code that processes the thumbnail image data, the code that displays on a display includes code that displays on the display device, thumbnail image data expressing the same page as the page of the printed document, in a second display method different from a first display method that is a method of displaying the thumbnail image data expressing the page included in the stored document and the page other than the printed document.

An image forming apparatus according to the present invention is capable of providing to a user, detailed information regarding the relation between the page of the printed document and a document expressed by a document/data file stored in a storage device, without printing out this document/data file, based on additional information expressed by additional data embedded in the page of the printed document that is in user's own hand.

The user can immediately know positioning, etc, of the page of the printed document at hand in the document of the page expressed by the data file, from the detailed information regarding the relation provided by the image processing device. Therefore, the present invention exhibits an advantage of improving usability of the image processing device.

### BRIEF DESCRIPTION OF THE DRAWINGS

The above and further objects and novel features of the invention will more fully appear from the following detailed description when the same is read in connection with the accompanying drawings, and in which:

FIG. 1 is a block diagram of a multifunction peripheral according to an embodiment of the present invention;

FIG. 2 is a block diagram from a functional viewpoint of the multifunction peripheral;

FIG. 3 is a block diagram concerning an additional data embedding function of the multifunction peripheral;

FIG. 4 is an example diagram of the additional data embedding processing of the multifunction peripheral;

FIG. 5 is a block diagram concerning an additional data detecting function of the multifunction peripheral;

FIG. 6 is an example diagram of additional data detection processing of the multifunction peripheral;

FIG. 7 is a flowchart of document detailed information display processing of the multifunction peripheral;

FIG. 8 is an example diagram of an operation unit of the multifunction peripheral;

FIG. 9 is a flowchart showing details of step of the flowchart shown in FIG. 7;

FIG. 10 is an example diagram of the display of document detailed information of the multifunction peripheral; and

FIG. 11 is a flowchart of the processing concerning selection of a document of different revision.

It is to be expressly understood, however, that the drawings are for the purpose of illustration only and are not intended as definitions of the limits of the invention.

### DETAILED DESCRIPTION OF THE PREFERRED EMBODIMENTS

Preferred embodiments of the present invention will be explained hereafter, with reference to the appended drawings.

<Structure>

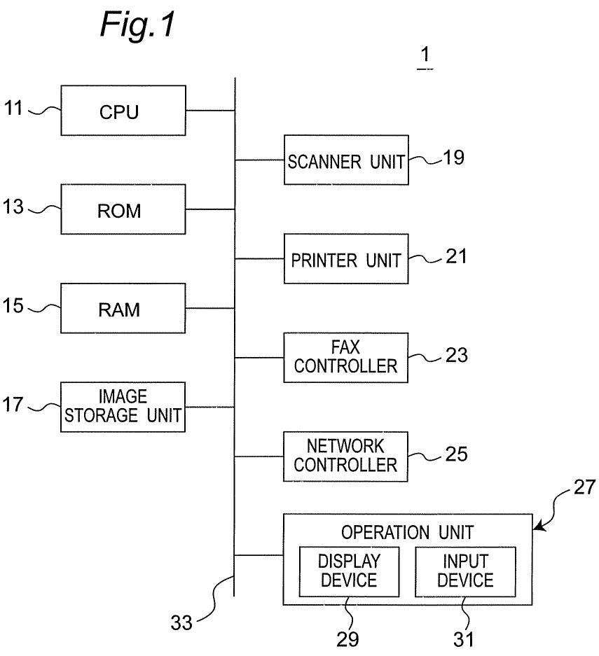

FIG. 1 is a block diagram of a structure of a multifunction peripheral 1 according to an embodiment of the present invention. In this embodiment, explanation will be given for the multifunction peripheral 1 as an example of the image processing device. However, the image processing device of the present invention is not limited to the multifunction peripheral.

The multifunction peripheral 1 includes a central processing unit (CPU) 11, a read only memory (ROM) 13, a random access memory (RAM) 15, an image storage unit 17, a scanner unit 19, a printer unit 21, a FAX controller 23, a network controller 25, and an operation unit 27. The aforementioned constituent element is connected so that data can be mutually transmitted and received via a bus 33. The operation unit 27 includes a display device 29 and an input device 31.

The CPU 11 is a processor capable of reading a program stored in a storage device such as the ROM 13, the RAM 15, and a auxiliary storage device (not shown), and capable of executing this program. The CPU 11 functions as a controller of the multifunction peripheral 1 which has functions of the present invention, by executing this program. In addition, by executing this program, the CPU 11 realizes the functions of the present invention, such as detection of the additional data, extraction of additional information, and processing based on the additional information, as will be described later. The ROM 13, the RAM 15, or the auxiliary storage device (not shown) stores the aforementioned program, and further store various data necessary for operating the multifunction peripheral 1.

The image storage unit 17 stores data files. The stored data files include a data file of the document (document image data), and a data file in which detailed information of the document is described (detailed document information data).

Note that it is not necessary to incorporate the image storage unit 17 in the multifunction peripheral 1. The image storage unit 17 may also exist outside of the multifunction peripheral 1. The image storage unit 17 can be constituted of a storage medium such as a hard disk, a nonvolatile memory, and an optical disc. Note that it is not necessary either to incorporate each constituent element other than the image storage medium 17 in the multifunction peripheral 1 respectively. They may exist outside of the multifunction peripheral 1.

The scanner unit 19 optically reads the image formed on a paper medium, etc, and generates the image data of the digital form from information of the scan image. The generated image data is sent to the CPU 11, etc, via the bus 33. The CPU 11, etc, can perform various processing such as generating and storing the data file from the image data.

The printer unit 21 acquires the image data from the CPU 11, etc, via the bus 33, and forms (prints) and outputs the image on the paper medium, etc.

The FAX controller 23 performs transmission/reception of data to/from outside by using a facsimile function.

The network controller 25 connects the multifunction peripheral 1 to the network such as local area network (LAN) and the Internet. Also, the multifunction peripheral 1 is capable of using an external device connected through the network controller 25, as the constituent element shown in FIG. 1. A method of realizing such a configuration is apparent for a person skilled in the art, and therefore detailed explanation therefore is not given here.

The operation unit 27 includes the display device 29 and the input device 31. The display device 29 is a device for displaying and outputting information to the user from the multifunction peripheral 1, and a liquid crystal display panel is given as an example of this display device 29. The input device 31 is a device for inputting information into the multifunction peripheral 1 by the user, and key buttons constituted on the surface of the body of the multifunction peripheral 1 are given as the example of the input device 31. In the multifunction peripheral 1, the display device 29 and the input device 31 are integrally formed with the liquid crystal touch panel.

The multifunction peripheral 1 having the aforementioned structure has functions such as a copy function, a print function, a scanner function, and a facsimile function. In addition, the multifunction peripheral 1 is capable of executing functions such as a network printing and transmission/reception of electronic mails, in cooperation with an outside input/output device connected via the network.

<Functional Structure>

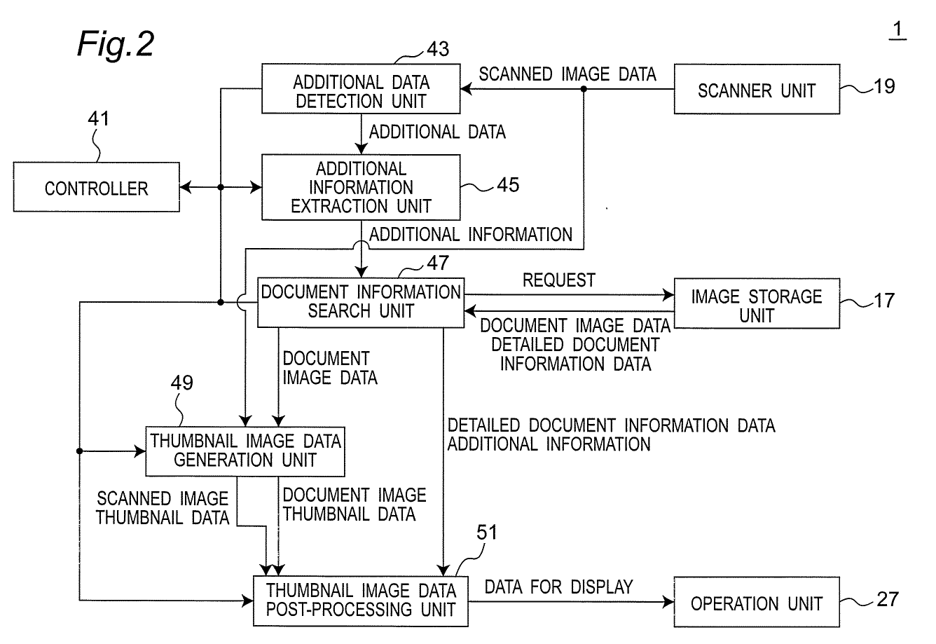

FIG. 2 is a block diagram of the structure of the multifunction peripheral 1 by blocks, from a functional viewpoint. The function of each block is realized by the program executed in the CPU 11 and the constituent elements of the multifunction peripheral shown in FIG. 1. Also, a functional block realized by a dedicated hardware circuit may exist. Note that the functional block not directly related to the present invention is not shown in FIG. 2, and explanation thereof is also omitted.

The multifunction peripheral 1 includes a controller 41, an additional data detection unit 43, an additional information extraction unit 45, a document information search unit 47, a thumbnail image data generation unit 49, and a thumbnail image data post-processing unit 51, as the functional blocks.

The controller 41 controls the operation of the multifunction peripheral 1.

The additional data detection unit 43 detects the data included in the image data of the page of the document (embedded additional data). The additional data detection unit 43 can receive from the scanner unit 19, the image data of the page of the printed document scanned by the scanner unit 19.

The additional information extraction unit 45 receives the additional data from the additional data detection unit 43, and extracts the information (additional information) expressed by this additional data.

The document information search unit 47 receives the additional information from the additional information extraction unit 45, and searches the data file stored in the image storage unit 17 with information included in this additional information set as a searching condition, and requests the data file corresponding to the search. The image storage unit 17 sends the requested document image data and/or the detailed document information data to the document information search unit 47.

The requested document image data includes document image data of the document including the page of the printed document therein, and document image data of other document having a prescribed relation with this document. Both of the document image data are scanned by the scanner unit 19.

The prescribed relation includes, for example, a relation interconnected in the relation of a revision history. Other document in the relation of a revised version includes the document revised from a reference document, or the document before being revised to the reference document.

The detailed document information data is the data related to detailed information regarding the document. For example, the detailed document information data includes the data concerning the aforementioned revised version, and the data concerning the printout number of copies heretofore, and so forth. Note that the detailed document information data may be included in the document image data and may be stored as one of the files.

The thumbnail image data generation unit 49 receives the document image data from the document information search unit 47, and generates data of the thumbnail image (document image thumbnail data) expressing each page of the document.

It is also possible that the thumbnail image data generation unit 49 receives scanned image data from the scanner unit 19, then generates the thumbnail image of the scanned image, and sends this thumbnail image to the thumbnail image data post-processing unit 51 as scanned image thumbnail data.

The thumbnail image may be the image schematically showing the content of the page of the document. In the thumbnail image, it is not always necessary to discriminate the characters, etc, included in the page of the document. Size and resolution, etc, of the thumbnail image may be suitably selected, in consideration of a specification of the display device 29, etc, of the operation unit 27.

The thumbnail image data post-processing unit 51 receives the document image thumbnail data from the thumbnail image data generation unit 49, and performs prescribed post-processing to the document image thumbnail data. Detailed explanation will be given later for this post-processing. In the post-processing, based on the detailed document information data and the additional information received from the document information search unit, the prescribed processing is performed to the thumbnail image data. The prescribed processing includes plural kinds of image processing. These plural kinds of image processing include the image processing of adding a frame of prescribed color to the thumbnail image schematically expressing one page of the document. Also, the plural kinds of image processing include a case of applying no image processing to the thumbnail image. The plural kinds of image processing may be the processing of making it possible to visually classify the thumbnail images into any one of the categories of the number corresponding to the number of times of the aforementioned plural kinds of image processing, when the thumbnail image displayed on the display device 27 is viewed by the user.

The document image thumbnail data subjected to this post-processing is sent to the operation unit 27 as the data for display.

Based on the data for display received from the thumbnail image data post-processing unit 51, the operation unit 27 can display information on the display device 29, and can receive the input from the user in the input device 31. The user can input the instruction into the multifunction peripheral 1 by using the input device 31, with reference to the information displayed on the display device 29.

In the multifunction peripheral 1 thus constituted, by scanning the page of the printed document that is already is user's own hand by means of the multifunction peripheral 1, the user can acquire from the display device 29 the detailed information of the document including the page of the printed document without printing out the document.

In the display of the detailed information in the display device 29, the thumbnail images of plural pages included in the document are displayed, and the page of the printed document possessed by the user can be displayed by applying thereto the image processing different from the processing performed to the thumbnail image of other page. Therefore, the user can know the position of the page of the printed document that is already in user's own hand in the entire body of the document without printing out the document.

In addition, when the image storage unit 17 of the multifunction peripheral 1 stores other document interconnected with the document including therein the page of the printed document possessed at hand of the user in the relation of the revised version, the multifunction peripheral 1 can notify the user of the storage of this other document, via the display device 29. The user, who knows that the revised version exists in the document at hand, can also display each page of this revised document, as the thumbnail image on the display device 29. Thereafter, the displayed revised version can also be printed out.

In addition, when the plural pages of the printed document possessed by the user at hand is scanned sequentially by the multifunction peripheral 1, it is also possible for the multifunction peripheral 1 to list-display the thumbnail image of each page of the document including at least one of the plural pages therein. At that time, in a case of including another page included in the same document as a specific one page of the plural pages subjected to scan, the multifunction peripheral 1 can display this another page, with image processing applied thereto, which is the image processing different from that applied to this specific one page of the same document and the pages of the aforementioned same document other than the aforementioned another page and the specific one page. Therefore, the user can know that another page included in the same document exists in the plural pages of the scanned and printed document possessed by the user at hand, without printing out the whole pages of the document.

In addition, the multifunction peripheral 1 can also notify the user of the document including therein the page of the scanned and printed document, other document interconnected with the aforementioned document in the relation of the revised version, and the number of printout copies of these documents heretofore, by displaying them on the display device 29. The user can instantaneously know which document includes the page of the document possessed by the user at hand, what revised document exists in this document, and how many printout copies of these documents have been printed out heretofore, by scanning the pages of the document possessed by the user at hand, using the multifunction peripheral 1. Based on the information provided by the multifunction peripheral 1, the user can determine presence/absence of a printout instruction, and this contributes to tremendously improving the usability.

<Embedding of the Additional Data>

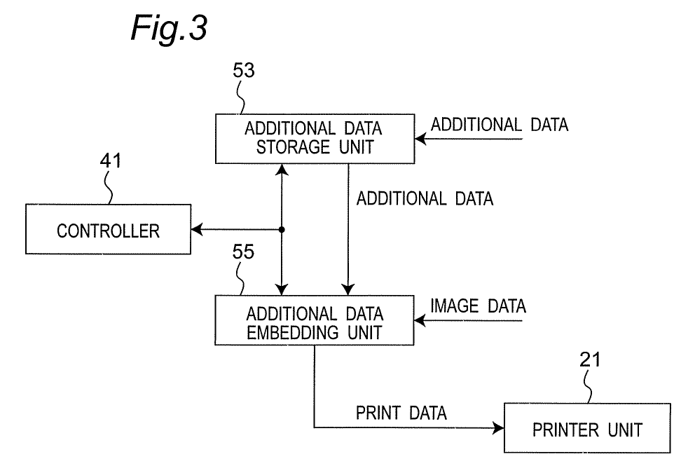

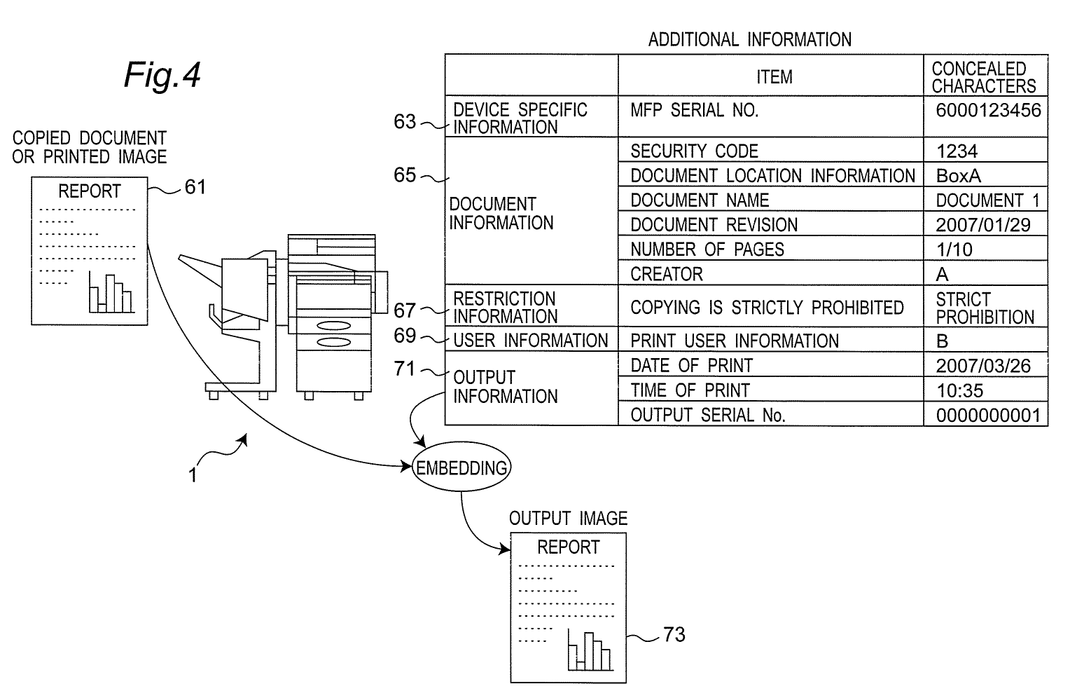

FIG. 3 and FIG. 4 are diagrams explaining embedding of the additional data in the page of the printed document.

FIG. 3 is a diagram of the structure of the multifunction peripheral 1, for performing print, etc, with the additional data embedded in the page of the document. The functions of the an additional data storage unit 53 and an additional data embedding unit 55 can be realized by the CPU 11, ROM 13, RAM 15, and the program executed in the CPU 11, or the dedicated hardware circuit. However, the aforementioned each functional block requires fast processing. Therefore, such each functional block is preferably realized by the dedicated hardware circuit.

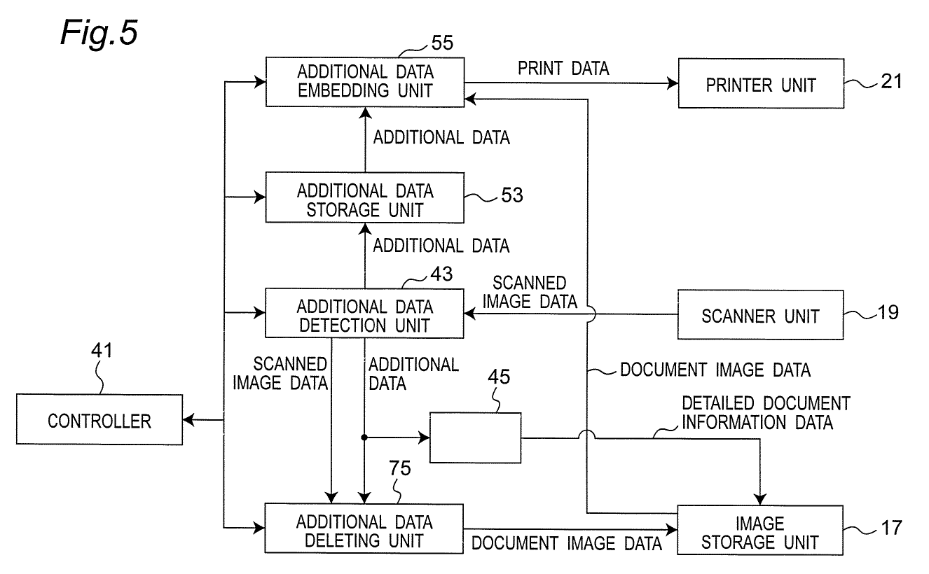

The additional data storage unit 53 holds the additional data embedded in the page of the printed document. Then, the additional data storage unit 53 sends the additional data to the additional data embedding unit 55 at a timing instructed by the controller 41. Here, the additional data is sent from, for example, the image storage unit 17 (FIG. 1, FIG. 2), the additional data detection unit 43 (FIG. 2), the network controller 25 (FIG. 5 1), and the operation unit 27 (FIG. 1, FIG. 2), and so forth. For example, the additional data is the detailed document information data stored in the image storage unit 17, etc, of the multifunction peripheral 1.

The image data of the page of the printed out document is sent to the additional data embedding unit 55. Here, the image data is sent from, for example, the image storage unit 17 (FIG. 1, FIG. 2), the scanner unit (FIG. 1, FIG. 2), and the network controller 25 (FIG. 1), and so forth. The image data sent from the image storage unit 17 is for example, a document image data.

The additional data embedding unit 55 functions to embed the additional data in the image data, and sends the additional data to the printer unit 21 as the print data. The printer unit 21 that receives the print data prints out the page of the document embedded with the additional data.

Here, the additional data may be embedded in the image data as a “concealed character”. The concealed character is image information embedded in the page of the document by using color tones, etc, which cannot be visualized by the user. As a matter of course, the scanner unit 19 (FIG. 1, FIG. 2) can optically scan the embedded concealed characters. In addition, the additional data may be embedded in the image data by giving a density pattern that can be hardly recognized, to the electronic watermark, a background pattern, or a type visually recognized by the user.

FIG. 4 is a schematic diagram of an example in which the additional data indicating the additional information is embedded in the page of the document, as the concealed characters.

When the image data is inputted into the multifunction peripheral 1 as the data of a copied document (or printed image) 61, the multifunction peripheral 1 sends this image data to the additional data embedding unit 55 (FIG. 3). At that time, the additional data (concealed characters) is sent to the additional data embedding unit 55 from the additional data storage unit 53 (FIG. 3).

The additional information embedded in the image data as the concealed characters includes for example, device specific information 63 of the multifunction peripheral that executes embedding of the additional data (concealed characters), document information 65, restriction information 67 regarding restriction, etc, of the image processing, user information 69 that is information regarding the user who inputs a print command, and output information 71 that is information regarding printout, and so forth. The document information 65 includes a security code, document location information indicating a storage location of the data of the document, a document name indicating the name of the document, document revision information indicating revision of the document, page number information indicating the page number in the document of this page, and creator information indicating a creator of the document, and so forth.

Note that when the additional information is embedded in the image data as the concealed characters, the additional information as it is may be embedded in the image data as a character string, or may be embedded in the image data after appropriate encoding, etc, is performed. Also, when the additional information is embedded in the image data as the background pattern, the electronic watermark, and density, the additional information is patterned according to an appropriate rule, and thereafter this pattern is embedded in the image data as the additional data.

The image data embedded with the additional data is outputted as an output image 73, for example.

<Detection of the Embedded Additional Data>

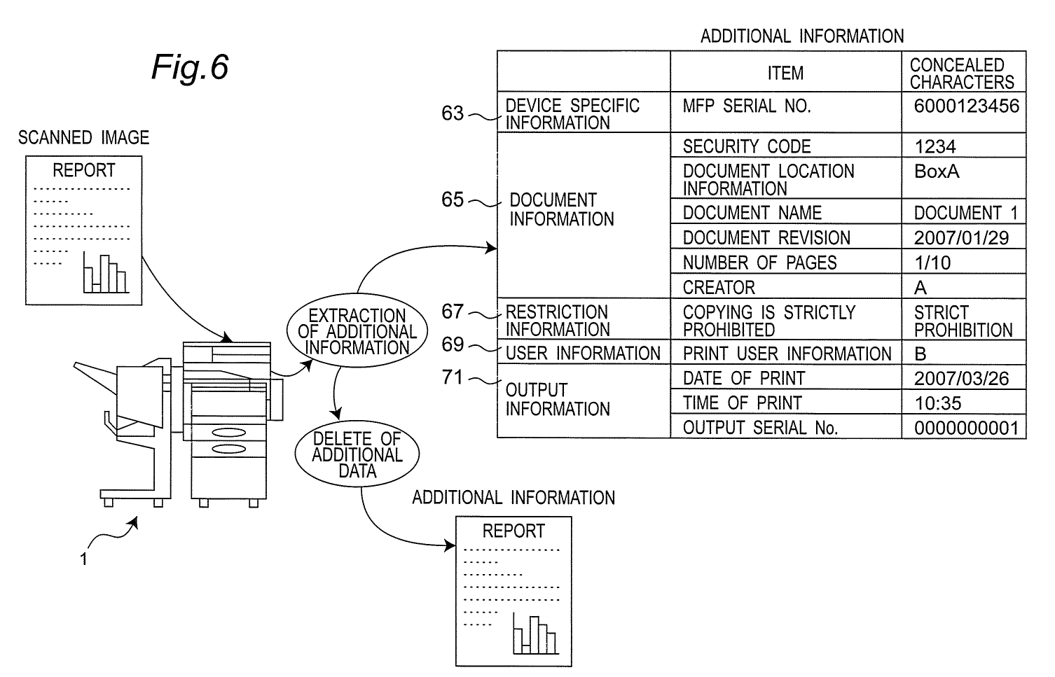

FIG. 5 and FIG. 6 are diagrams explaining the detection of the additional data embedded in the page of the printed document.

FIG. 5 is a diagram of the structure of the multifunction peripheral 1, for detecting the additional data embedded in the page of the printed document. The function of an additional data deleting unit 75 can be realized by the CPU 11, ROM 13, RAM 15, and the program executed in the CPU 11, or by the dedicated hardware circuit. The above-described functional block requires fast processing, and therefore preferably realized by the dedicated hardware circuit.

First, the image data scanned by the scanner unit 19 is sent to the additional data detection unit 43 as scanned image data. The additional data detection unit 43 detects the additional data included in the scanned image data, and sends the detected additional data to the additional data deleting unit 75, the additional information extraction unit 45, and the additional data storage unit 53. In addition, the additional data detection unit 43 sends the scanned image data to the additional data deleting unit 75.

The additional data deleting unit 75 receives the additional data and the scanned image data from the additional data detection unit 43, then deletes the additional data from the scanned image data, and restores a damaged part when the image is damaged by delete. The scanned image data which is restored, with the additional data deleted, is sent to the image storage unit 17 as the document image data. The image storage unit 17 can store the received document image data. When the detailed document information data of the document shown in the document image data is simultaneously stored, as will be described later, the additional information is extracted from the additional data and the detailed document information data is constituted.

The additional information extraction unit 45 extracts the additional information from the additional data received from the additional data detection unit 43. The extracted additional information is sent to the image storage unit 17 as the detailed document information data. The image storage unit 17 stores the received detailed document information data.

The additional data storage unit 53 stores the additional data received from the additional data detection unit 43, and sends the additional data to the additional data embedding unit 55 as needed, according to an instruction from the controller 41.

The additional data embedding unit 55 further receives the document image data from the image storage unit 17, and embeds the additional data in the document image data. The document image data embedded with the additional data is sent to the printer unit 21 as print data. The printer unit 21 performs printout by using the received print data.

Thus, the multifunction peripheral 1 detects the additional data included in the scanned image data generated by reading the page of the document by the scanner unit 19. The image storage unit 17 can store the restored document image data which is restored, with the additional data deleted, as needed. The additional information expressed by the additional data can also be stored in the image storage unit 17 as the detailed document information data. When the scanned image data is printed out, it is also possible to print out the scanned image data after the additional data is embedded again in the document image data, with the additional data deleted once. As a matter of course, it is also possible to send the scanned image data as it is, to the printer unit 21 to be printed out.

FIG. 6 is a schematic diagram of an example of detecting the additional data from the page of the document embedded with the additional data indicating the additional information as the concealed characters.

When the page of the document is inputted as the scanned document, the multifunction peripheral 1 generates the scanned image data and sends the generated data to the additional data detection unit 43 (FIG. 5).

The additional data detection unit 43 (FIG. 5) detects the additional data from the received scanned image data, and sends the detected additional data to the additional data deleting unit 75, the additional information extraction unit 45, and the additional data storage unit 53 (FIG. 5).

As described above, the additional data deleting unit 75 deletes the additional data from the scanned image data, then restores the scanned image data, and sends the additional data to the image storage unit 17 as the document image data. Therefore, the multifunction peripheral 1 can restore the page of the document embedded with the additional data to a state in which no additional data is embedded, and thereafter can store this restored image data in the image storage unit 17 as the document image data.

The additional information extraction unit 45 extracts the additional information from the received additional data as described above. In FIG. 6, the extracted additional information includes the device specific information 63, the document information 65, the restriction information 67, the user information 69, and the output information 71, and so forth. The additional information extraction unit 45 can send at least a part of the extracted additional information, for example the document information 65, to the image storage unit 17, as the detailed document information data.

<Document Detailed Information Display Processing>

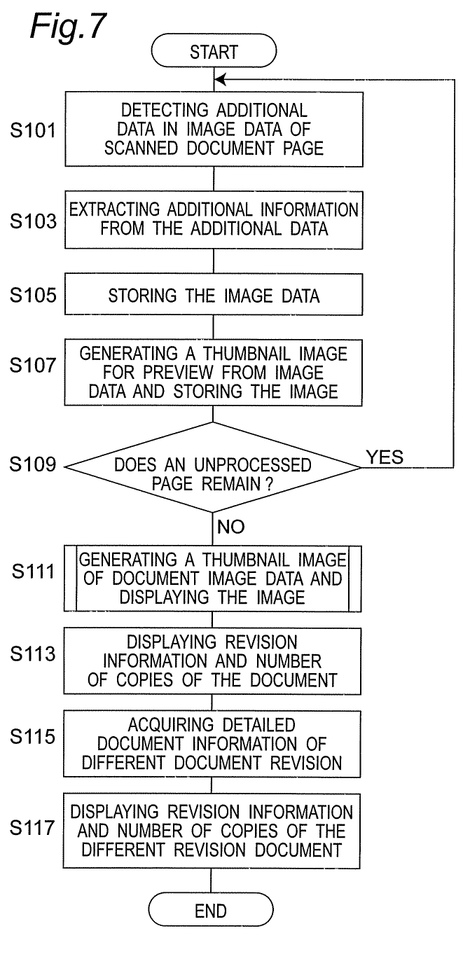

FIG. 7 is a flowchart showing the flow of the processing from inputting the image of the page of the document embedded with the additional data, up to displaying detailed information concerning this document on the display device 29 (FIG. 1) of the operation unit 27.

The multifunction peripheral 1 has an operation mode in which the input of the image of the page of the document embedded with the additional data is received, and the detailed information regarding this document is provided to the user. Here, this operation mode is called a “document search mode”. FIG. 7 is a flowchart of the processing concerning the document search mode.

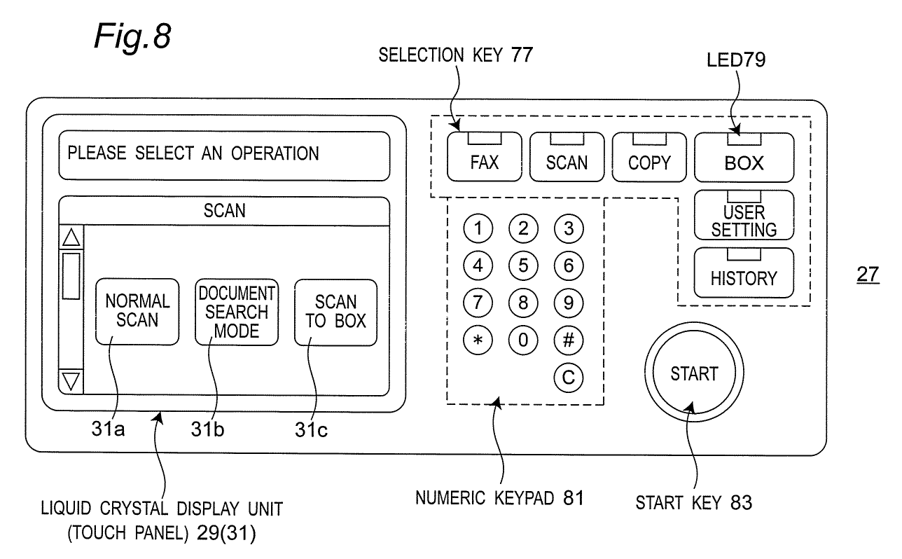

FIG. 8 is a diagram of a constitutional example of the operation unit 27 of the multifunction peripheral 1. The operation unit 27 includes a liquid crystal display unit (display device 29) constituted of a liquid crystal touch panel, and the input device 31 constituted of the same liquid crystal touch panel, selection keys 77, a numeric keypad, and a start key 83. Also, the selection keys 77 include a light emitting diode (LED) 79 for expressing a selected state.

The user selects the scan by using the selection keys 77 first, and next, touches the “document search mode” 31b from the touch buttons 31a, 31b, 31c displayed on the liquid crystal display unit 29, to select the document search mode, and presses down the start key 83. When press-down of the start key 83 is recognized, the multifunction peripheral 1 optically scans the page of the document placed on a platen (not shown) of the multifunction peripheral 1, in the document search mode. The document placed on the platen may not be one page. When plural pages of the document are placed on the platen, the plural pages are sequentially scanned.

Note that this embodiment shows an example of optically reading the page of the printed document and detecting the additional data included in this page. However, the input of the image of the page of the document into the multifunction peripheral 1 is not limited to an optical scan. For example, the multifunction peripheral 1 may input the data concerning the page of the document embedded with the additional data, from the external device, via the network controller 25 (FIG. 1).

Returning to FIG. 7, in step S101, the additional data detection unit 43 (FIG. 2) of the multifunction peripheral 1 detects the additional data from the image data of one page of the scanned document. The additional data detection unit 43 sends the detected additional data to the additional information extraction unit 45 (FIG. 2).

In step S103, the additional information extraction unit 45 of the multifunction peripheral 1 extracts the additional information from the received additional data. The additional information extraction unit 45 sends the extracted additional information to the document information search unit 47.

In step S105, the thumbnail image data generation unit 49 (FIG. 2) receives the image data of one page of the scanned document, and stores the received image data in a memory.

In step S107, the thumbnail image data generation unit 49 generates the thumbnail image (scanned image thumbnail data) for preview from the image data of one page of the scan document stored in the memory, and stores the thumbnail image in the memory.

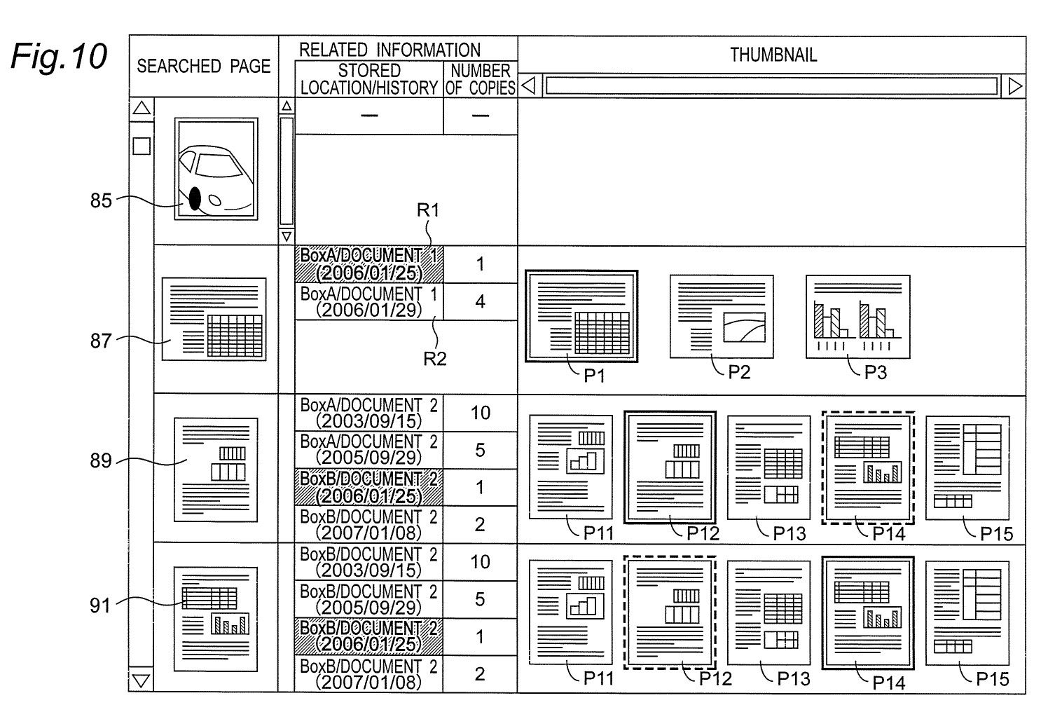

FIG. 10 is a diagram of a document search result display screen displayed on the display device 29 of the operation unit 27. The scanned image thumbnail data for preview generated in step S107 is displayed in a column of “search page” in the display device 29. Here, search pages 85, 87, 89, 91 of four page portion are displayed for preview. The name such as “search page” is derived from a fact that the information of the document having a prescribed relation is displayed at the right side of the thumbnail image displayed for preview, using the information based on the additional data included in the page of the scanned document as the key of the search. In this embodiment, when there are five pages or more of the pages of sequentially scan (scanned) document, the user can view other pages by using a touch key for scroll of a screen, thereby scrolling the screen.

Returning to FIG. 7, in step S109, the controller 41 (FIG. 2) of the multifunction peripheral 1 determines whether or not there are pages not subjected to a series of processing yet from step S101 up to step S107, out of the image data generated by reading (scanning) the page of the document placed on the platen (not shown). When there is an unprocessed page (image data) remained (“YES” in step S109), the processing is returned to step S101, and the aforementioned processing is performed to the unprocessed page (image data). When it is so determined that there is no unprocessed page (image data) remained, (“NO” in step S109), the processing is moved to step S111.

In step S111, based on the received additional information, the document information search unit 47 (FIG. 2) searches the document including the page of the scanned document, and requests the document image data and the detailed document information data of this document to the image storage unit 17 (FIG. 2). The image storage unit 17 that receives the request sends the document image data and the detailed document information data to the document information search unit 47. The document information search unit 47 sends the received document image data to the thumbnail image data generation unit 49, and sends the received detailed document information data and the additional information to the thumbnail image data post-processing unit 51. The thumbnail image data generation unit 49 and the thumbnail image data post-processing unit 51 processes the received document image data, the detailed document information data, and the additional information, then generates the data for display, and sends the resulting data to the operation unit 27. The operation unit 27 displays the received data for display on the display device 29. Note that details of step S111 will be described in detail later.

With reference to FIG. 10, it is found that each page of the document stored in the image storage unit 17 including therein each page of the scan document is displayed as the thumbnail image (P1 to P3, and P11 to P15).

Returning to FIG. 7, in step S113, the thumbnail image data post-processing unit 51 of the multifunction peripheral 1 processes the additional information and the detailed document information data, then generates the data for display, and sends the resulting data to the operation unit 27. For example, the data for display includes information regarding the revision of this document or information regarding the number of copies heretofore. The operation unit 27 displays the received data for display on the display device 29.

With reference to FIG. 10, regarding each document stored in the image storage unit 17 including therein each page (85, 87, 89, 91) of the scanned document, stored locations and the history of revision in the image storage unit 17, and the number of copies heretofore are displayed in the column of the “related information” (for example, display R1 and R2). The display R1 is an emphasized display. This emphasized display shows the document including pages P1 to P3 displayed as thumbnail. Also, thumbnail image P1 is the emphasized display, with a red frame added thereto. (In the figure, the red frame is expressed by a frame of a thick solid line.) This red frame is added, for indicating the page of the scanned document (searched page 87) distinguishably from other pages. Thus, by differentiating a display system between a thumbnail display system of the page of the document scan from the platen and the display system of another page in the document, the user can instantaneously know which of the pages in the whole body of the document corresponds to the page of the document possessed by the user at hand, without performing printout. Also, needless to say, in the column of the “related information”, the user can know a fact that the document corresponding to the revised version of the document possessed by the user at hand is stored in the image storage unit 17, and also can know a fact that four copies of the revised versions have been outputted heretofore.

Returning to FIG. 7, in step S115, based on the additional information, the document information search unit 47 of the multifunction peripheral 1 searches other document stored in the image storage unit 17, having a prescribed relation with the document including therein one page of the scanned document. Here, the prescribed relation is a relation of the revised version defined by a document name and document revision, etc, included in the document information 65 of the additional information (FIG. 4). For example, the document information search unit 47 gives request to the image storage unit 17, the detailed document information data of the document having the same document name and having different document revisions.

Then, in step S117, the document information search unit 47 sends to the thumbnail image data post-processing unit 51, the detailed document information data of the aforementioned other document stored in the image storage unit 17, received from the image storage unit 17. The thumbnail image data post-processing unit 51 processes the detailed document information data, and then generates the data for display and sends the resulting data to the operation unit 27. The data for display includes information regarding the revision of the aforementioned other document (different revision) and information regarding the number of copies heretofore. The operation unit 27 displays the received data for display on the display device 29.

With reference to FIG. 10, for example, it is found that the normally displayed display R2 is displayed, separately from the emphatically displayed display R1 in the column of the related information. This display R2 is information regarding the document of a different revision of the document including an image 87 displayed for preview.

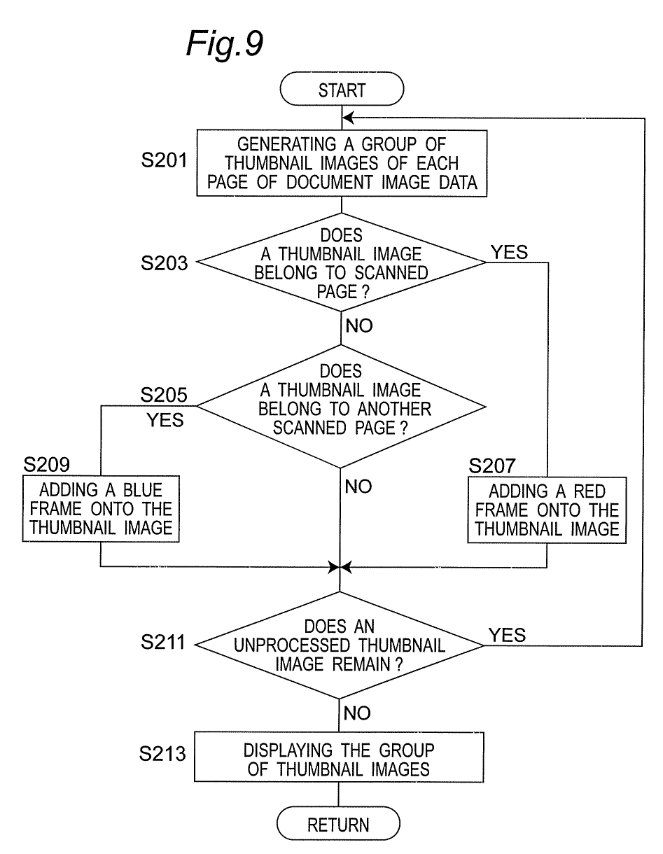

Next, details of the processing in step S111 will be explained, with reference to FIG. 9.

In step S201, the thumbnail image data generation unit 49 of the multifunction peripheral 1 generates the thumbnail image data of a size suitable for list-displaying this image data on the display device 29. The thumbnail image data generation unit 49 sends the generated thumbnail image data to the thumbnail image data post-processing unit 51, as the document image thumbnail data.

In step S203, based on the additional information and/or the detailed document information data, the thumbnail image data post-processing unit 51 determines whether or not the document image thumbnail data is the document image thumbnail data expressing a specific one page of the document scanned sequentially by the multifunction peripheral 1. When this document image thumbnail data is the document image thumbnail data expressing the specific one page of the document scan by the multifunction peripheral 1 (“YES” in step S203), the processing is advanced to step S207. When this document image thumbnail data is not the document image thumbnail data expressing the specific one page of the document scan by the multifunction peripheral 1 (“NO” in step S203), the processing is advanced to step S211.

In step S205, based on the additional information and/or the detailed document information data, the thumbnail image data post-processing unit 51 determines whether or not the document image thumbnail data is included in a page group of the document sequentially ready by the multifunction peripheral 1 and is the document image thumbnail data expressing the image of the page different from the aforementioned specific one page. When this document image thumbnail data is included in the page group of the document sequentially scan by the multifunction peripheral 1, and is the document image thumbnail data expressing the image of the page different from the aforementioned specific one page (“YES” in step S205), the processing is advanced to step S209. When the received document image thumbnail data is included in the page group of the document sequentially scan by the multifunction peripheral 1, and is not the document image thumbnail data expressing the image of the page different from the aforementioned specific one page (“NO” in step S203), the processing is advance to step S211.

Here, the “specific one page” in step S203 and S205 indicates the page that is displayed for preview and is a key of the search in the display on the display device 29. With reference to FIG. 10, in a row in which the image 87 is displayed (the row is set in the horizontal direction in the figure), the page expressed by the image 87 and the thumbnail image Pi corresponds to the “specific one page”. In the row in which an image 89 is displayed, the page expressed by the image 89 and a thumbnail image P12 corresponds to the “specific one page”, and simultaneously in the row in which an image 91 is expressed, the page expressed by the image 91 and a thumbnail image P14 corresponds to the “specific one page”. Thus, the “specific one page” is changed and set in each row in the display of the display device 29, and thereby the determination in step S203 and S205 is performed.

In addition, it can be said that the “page different from the aforementioned specific one page” in the explanation of step S205 is the page included in the document including therein the page as the key of the search, and is the page excluding the page as the key of the search.

In step S207, first image processing is performed to the document image thumbnail data. Here, the first image processing is the processing of adding the red frame to the document thumbnail image.

Note that instead of the processing of step S207, it is also possible to perform the processing in the display device 29, in which the red frame is overlapped on the document thumbnail image in a superposition manner.

In step S209, second image processing is performed to the document image thumbnail data. Here, the second image processing is the processing of adding a blue frame to the document thumbnail image.

Note that instead of the processing of step S209, it is also possible to perform the processing in the display device 29, in which the blue frame is overlapped on the document thumbnail image in a superposition manner.

In step S211, it is determined whether or not the document image thumbnail data still remains, the data not subjected to a series of the processing from step S201 up to the steps S205, S207, or S209. When unprocessed document image thumbnail data remains (“YES” in step S211), the processing is returned to step S201, and the processing is performed to the next document image thumbnail data. When the unprocessed document image thumbnail data does not remain (“NO” in step S211), the processing is advanced to step S211.

In step S213, a document thumbnail image group is displayed on the display device 29.

With reference to FIG. 10, a search result is list-displayed, regarding four pages of the pages of the document sequentially scanned by the multifunction peripheral 1.

First, regarding the page expressed by the image 85, the document image data and the detailed document information data of the document including this page are not stored in the image storage unit 17, and therefore both of the related information and the thumbnail image are not displayed.

Next, regarding the page expressed by the image 87, the document image data and the detailed document information data of the document including this page therein are stored in the image storage unit 17, and further there exists other document interconnected with this document in the relation of revised version. Therefore, the information of this document and the number of copies of each document are displayed as the displays R1 and R2. In addition, each page of the document concerning the emphatically displayed display R1 is displayed in the column of the thumbnail image. Among them, the red frame indicating the same page as the page, which is the key of the search, is added to the thumbnail image P1.

Next, regarding each page expressed by the images 89 and 91, the document image data and the detailed document information data of one document including this page are stored in the image storage unit 17, and further other document interconnected with this document in the relation of revised version is stored in the image storage unit 17. Therefore, the information of this document and the number of copies of each document are displayed. In the row in which the image 89 is displayed, the red frame indicating the same page as the page is added to the thumbnail image P12 that is the key of the search, and the blue frame (the blue frame is expressed by a thick broken line in the figure) is added to the thumbnail image P14. By viewing the display of the blue frame, the user can know a fact that another page included in the same document as the document including therein the page that is the key of the search, exists in the page group of the document possessed by the user at hand and sequentially scanned by multifunction peripheral 1. In the row in which the image 91 is displayed, the blue frame is added to the thumbnail image P12 in an opposite way to the row in which the image 89 is displayed, and the red frame is displayed in the thumbnail image P14.

Thus, the multifunction peripheral 1 according to an embodiment of the present invention can detect the additional data embedded in the page of the document, and can show to the user, the existence of the document stored in the multifunction peripheral 1 including this page.

When the document stored in the multifunction peripheral 1 is shown, it is possible to clearly visually show which page in the document corresponds to the page of the document scanned by the multifunction peripheral 1, by displaying, for example, the thumbnail image. The user can grasp an outline of the document without printing out the whole pages of the document.

In addition, when the revised version exits and is stored in the multifunction peripheral 1 in the aforementioned document stored in the multifunction peripheral 1, detailed information concerning the revised document can be notified to the user. The detailed information can include revised date and the number of printout copies heretofore. The user can know the revision history of the document, and from the number of printout copies, can estimate a use frequency, etc, and can know the importance of this document.

Also, the user can know the page possessed by the user at hand, out of the pages of the document stored in the multifunction peripheral 1. Therefore, the user can know the existence of the page not possessed by the user at hand. Also, regarding the document of a plurality of pages possessed by the user at hand, the user can know the mutual relation among them.

In the multifunction peripheral 1 according to the embodiment of the present invention, the improved effect of the usability is exhibited particularly in the following situations:

a situation in which only particularly important page of the pages included in the document is possessed by the user at hand, and other pages of this document are printed out as needed;

a situation in which only particularly important pages are distributed to participants in a conference, etc, and other pages of the document are printed out by the participants as needed;

a situation in which the user needs to know the mutual relation among plural pages, in a status where the user possesses the document of plural pages at hand; and

a situation in which the user wish to confirm whether or not the document possessed by the user at hand is a newest revised version.

<Thumbnail Display of the Document of a different Revision>

In addition, the user can display the thumbnail image, etc, of the different document interconnected in the relation of revised version on the display device 29 by operating the input device 31.

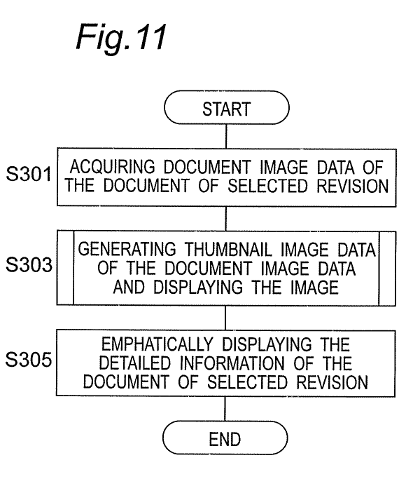

FIG. 11 is a flowchart of the processing concerning the display of the details of the document of the different revision.

In step S301, the multifunction peripheral 1 reads the document image data concerning the document of the different revision selected by the user, from the image storage unit 17.

In step S303, regarding the document of the different revision, the multifunction peripheral 1 generates and displays the thumbnail image data. Note that step S303 is the processing similar to the processing of step S111. However, the processing of adding the red frame or the blue frame performed to the thumbnail image data is performed based on a comparison between the page of the scanned document and the document image thumbnail data of this different revision. Therefore, the thumbnail image added with the red frame disappears. The thumbnail image added with the blue frame exists in some cases.

In step S305, the multifunction peripheral 1 changes the emphatically displayed revision in the column of the related information of the display device 29, to the revision selected by the user. For example, in FIG. 10, when the revision concerning the display R2 is selected, the display of the display R1 is changed to a normal display, and the display of the display R2 is changed to an emphasized display from the normal display.

Thus, regarding the document data file not possessed by the user at hand, the multifunction peripheral 1 according to this embodiment can present the detailed information of this document data file and the thumbnail image of each page, to the user without printing out them. The user obtains the aforementioned presentation and it becomes easy to select and print out the document of the different revision.

Note that in the present invention, the detailed information concerning the page of this document needs not to be completely included in the additional data embedded in the page of the document inputted in the image processing device, such as the page of the printed document. The additional data may express only minimum information (for example, associating information with information stored in the image processing device) capable of accessing the information stored in the image processing device.

Note that it is also possible to implement the present invention, by constituting the scanner unit, the printer unit, and the controller of the present invention, by using a general purpose information processing apparatus such as a scanner, a printer, a personal computer that separately and independently exist.

Note that the program implementing the embodiment of the present invention may be stored in the storage device in the image processing device. In addition, the aforementioned program can be circulated in a state of being held in the storage medium such as a flexible disc, an optical disc, and a nonvolatile memory including the USB memory. In addition, the aforementioned program can be distributed via the network.

The present invention has an advantage of improving the usability of the image processing device. The present invention is useful in an image processing field.

As this invention may be embodied in several forms without departing from the spirit of essential characteristic thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. An image processing device capable of inputting an image of a page of a printed document, comprising:
an additional data detection unit that detects additional data included in image data of the image of the page of said printed document;
an additional information extraction unit that extracts additional information indicated by said additional data;
a storage unit that stores data of the document and data of detailed information of said document;
a document information search unit that acquires the data of the document stored in said storage unit, the document including the page of said printed document, and the data of the detailed information of said stored document;
a thumbnail image data generation unit that generates thumbnail image data of the page of said stored document by processing the data of said stored document, based on said additional information;
a thumbnail image data post-processing unit that processes said thumbnail image data, based on said additional information; and
a display device that displays at least a part of information indicated by the data of the detailed information of said stored document, and said thumbnail image data processed by said thumbnail image data post-processing unit;
wherein
the image processing device displaying the thumbnail image data expressing the same page as the page of said printed document on the display device, in a second display method different from a first display method that is a method for displaying the thumbnail image data expressing the page included in said stored document and the page other than the page of said printed document.

2. The image processing device according to claim 1, wherein:
the image processing device is capable of sequentially inputting images of the pages of said plurality of printed documents; and,
regarding each page of said printed documents, the thumbnail image data expressing the page other than the page of said printed document that is the page included in said stored document, and the same page as the page included in said plurality of stored documents, is displayed on said display device in a third display method different from said first display method and said second display method.

3. The image processing device according to claim 1, wherein:
said additional information includes information regarding a revision history of the document including the page of said printed document;
based on said additional information, said document information search unit acquires from said storage unit the data of the detailed information of other document interconnected with the document stored in said storage unit including the page of said printed document, in a relation of a revised version; and
said display device displays at least a part of the detailed information of said other document.

4. The image processing device according to claim 1, wherein:
the data of the detailed information of said document and said other document includes the data regarding the number of copies; and
said display device displays information regarding the number of copies of said document and said other document.

5. An image processing method for processing an image of a page of a printed document, comprising:
inputting the image of the page of the printed document;
detecting additional data included in image data of the image of the page of said printed document;
extracting additional information indicated by said additional data;
acquiring data of the document stored in a storage unit, including the page of said printed document, and acquiring the data of detailed information of said stored document, based on said additional information;
generating a thumbnail image data of the page of said stored document, by processing the data of said stored document, based on said additional information;
processing said thumbnail image data based on said additional information; and
displaying said thumbnail image data processed in the processing at least a part of information indicated by the data of the detailed information of said stored document and said thumbnail image data;
wherein
said displaying includes displaying the thumbnail image data expressing the same page as the page of said printed document, in a second display method different from a first display method that is a method of displaying the thumbnail image data expressing the page included in said stored document and the page other than the page of said printed document.

6. The image processing method according to claim 5, wherein:
said inputting the image of the page includes sequentially inputting the images of the pages of a plurality of printed documents; and
regarding each page of said printed document, said displaying includes displaying the thumbnail image data expressing the page included in said stored document and the page other than the page of said printed document, and the same page as the page included in the page of said plurality of printed documents, in a third display method different from said first display method and said second display method.

7. The image processing method according to claim 5, wherein:
said additional information includes information regarding a revision history of the document including the page of said printed document;
said acquiring the data includes acquiring from said storage unit the data of the detailed information of other document interconnected with the document stored in said storage unit including the page of said printed document, in a relation of a revised version, based on said additional information; and
said displaying includes displaying at least a part of the detailed information of said other document.

8. The image processing method according to claim 5, wherein:
the data of the detailed information of said document and said other document includes the data regarding the number of copies; and
said displaying displays information regarding the number of copies of said document and said other document.

9. A computer-readable medium storing an image processing program executed by a computer of an image processing device capable of inputting an image of a page of a printed document, the program comprising:
code that inputs an image of a page of a printed document;
code that detects additional data included in image data of the image of the page of said printed document;
code that extracts additional information indicated by said additional data;
code that acquires data of the document stored in a storage unit of said image processing device, including the page of said printed document, and acquiring data of detailed information of said stored document;
code that generates thumbnail image data of the page of said stored document by processing the data of said stored document based on said additional information;
code that processes said thumbnail image data based on said additional information; and
code that displays on a display device of said image processing device, at least a part of information indicated by the data of the detailed information of said stored document, and said thumbnail image data processed in the step of processing said thumbnail image data,
wherein
said code that displays on a display device includes code that displays on said display device, thumbnail image data expressing the same page as the page of said printed document, in a second display method different from a first display method that is a method of displaying the thumbnail image data expressing the page included in said stored document and the page other than said printed document.

10. The image processing program according to claim 9, wherein
said code that inputs an image of the page includes code that sequentially inputs the images of pages of a plurality of printed documents; and
regarding each page of said printed documents, said code that displays on a display device includes code that displays on said display device the thumbnail image data expressing the page included in the document stored in said storage device, and the page other than the page of said printed document, and the same page as the pages included in said plurality of printed documents, in a third display method different from said first display method and said second display method.

11. The image processing program according to claim 9, wherein:
said additional information includes information regarding a revision history of the document including therein the page of said printed document;
said code that acquires data of the document includes code that acquires from a storage unit, the data of detailed information of other document interconnected with the document stored in said storage unit, including the page of said printed document, in a relation of a revised version; and
said code that displays on a display device includes code that displays on said display device, at least a part of the detailed information of said other document.

12. The image processing program according to claim 9, wherein:
the data of the detailed information of said document and said other document includes the data regarding the number of copies; and
said code that displays on a display device includes code that displays information regarding the number of copies of said document and said other document.
